(19) United States
(12) Patent Application Publication
(10) Pub. No.: US 2015/0160740 A1
(43) Pub. Date: Jun. 11, 2015

(54) METHOD AND APPARATUS FOR TEXT INPUT VIA REMOTE CONTROL

(71) Applicants: Mats Cedervall, Harnosand (SE); Michail Årman, Bromma (SE); Fredrik Persson, Alvsjo (SE)

(72) Inventors: Mats Cedervall, Harnosand (SE); Michail Årman, Bromma (SE); Fredrik Persson, Alvsjo (SE)

(73) Assignee: Telefonaktiebolaget L M Ericsson (PUBL), Stockholm (SE)

(21) Appl. No.: 14/380,354

(22) PCT Filed: Feb. 28, 2012
(86) PCT No.: PCT/EP2012/053326

§ 371 Date: Dec. 18, 2014

(51) Int. Cl. G06F 3/023

(52) U.S. Cl. CPC G06F 3/0235

(57) ABSTRACT

There is provided a method for text input using a device having at least a first set of keys and a second set of keys. The method comprises receiving an activation of a first key, the first key belonging to one of the first and second sets of keys. The activation of the first key selects a subset of characters. The method further comprises receiving an activation of a second key, the second key belonging to the set of keys other to that which the first key belongs. The activation of the second key selects a character for text input from the subset of characters selected by the activation of the first key.

### TECHNICAL FIELD

The present application relates to a method for text input, a computer-readable medium, and a device for receiving text input.

### BACKGROUND

The increasingly elaborate user interfaces for set-top-boxes, games consoles, home theatre PCs, PVRs and smart TVs place ever increasing demands on the remote controls for these devices. It is becoming increasingly common for a user to input text into a user interface using their remote control. For example, as electronic program guides (EPGs) become larger and cover more channels, user interfaces relating to these often now include a search function. An EPG search function allows a user to input the first few characters of the name of a program that they are looking for. The user interface displays a list of programs matching the search criteria, allowing the user to quickly locate the program of interest.

Further, many of today's TV systems are connected to the internet, such as “connected TVs” that are connected to the open internet, or IPTV systems where the TV or STB are connected to the internet and to managed IPTV system. In these connected systems there may be many applications that require text input, examples of popular applications are Facebook, Twitter, Movie search applications, Instant Messaging, Email, Web-browsing etc.

A problem with existing systems for text input using a remote control is that they are slow. Examples of these slow systems are multi-tap, and menu systems where the user must choose the correct letter on the screen with the left, right, up and down buttons.

“TNT—a numeric keypad based text input method” by Magnus Ingmarsson et al, published in the proceedings of the ACM Conference on Human Factors in Computing Systems (CHI) (2004), describes a text input system using a remote control. The Numpad Typer (TNT) works by letting the user press two numeric keys to produce a letter on the screen. A total of 81 letters, symbols, or commands are laid out on a 3 by 3 grid containing a plurality of 3 by 3 grids; the 3 by 3 grid spatially corresponding to the 3 column and 3 row numeric keys in the keypad. The first key press selects a group, and the second selects a member in that group. For example, in order to produce the letter “b”, the user first presses 1 on the keypad, this will produce feedback on the screen by highlighting the first group of letters. After this, the user knows that the first group is activated. The user then proceeds to press key 2 on the keypad, which selects the corresponding letter “b” in the selected group.

There is a need for an improved method and apparatus for text input via remote control.

### SUMMARY

Accordingly, there is provided a method for text input using a device having at least a first set of keys and a second set of keys. The method comprises receiving an activation of a first key, the first key belonging to one of the first and second sets of keys. The activation of the first key selects a subset of characters. The method further comprises receiving an activation of a second key, the second key belonging to the set of keys other to that which the first key belongs. The activation of the second key selects a character for text input from the subset of characters selected by the activation of the first key.

By using two sets of keys, quick and efficient text input is possible. In multi-tap text input, a user input of “soil” requires the following key presses: 7-7-7-7-6-6-6-4-4-4-5-5-5. An advantage of the method and apparatus disclosed herein, over multi-tap, is that every character is selected by two button presses, and so the average number of taps or key presses per letter is lower.

Further, in multi-tap text input, a user input of “cat” requires the following key presses: 2-2-2-pause-2-8. An advantage of the method and apparatus disclosed herein, over multi-tap, is that every character is selected using definitive button presses, and so no pause (or confirmation button press) is necessary.

In TNT, one set of 9 keys is used, giving 81 combinations. Given an alphabet of 26 characters, the TNT system has a lot of redundancy. Further, because one set of keys is used, the system lends itself to one digit (a finger or thumb) operation. An advantage of the system described herein is that the two sets of keys used lends itself to two handed—or at least two digit operation, with the user dedicating a digit to each set of keys. This allows for quicker and more efficient text input.

The method may further comprise receiving a further activation of the first key prior to receiving an activation of a second key, and cancelling a first selection of a subset of characters in response thereto.

The activation of the first key may be a press and release. The activation of the first key may be a key press. The method may be implemented such that activation of the second key must be made before the first key press is released.

The method may further comprise selecting a character for text input from the subset of characters upon detection of a release of the first key before an activation of a second key. A different character may be selected by releasing the first key as compared to keeping the first key pressed and pressing a second key. Releasing the first key may select a character that could also be detected by pressing a second key.

There is further provided a computer-readable medium, carrying instructions, which, when executed by computer logic, causes said computer logic to carry out any of the methods defined herein. There is further provided a computer-readable storage medium, storing instructions, which, when executed by computer logic, causes said computer logic to carry out any of the methods defined herein.

There is further provided a device for receiving text input, the device comprising a receiver and a processor. The receiver is arranged to receive activations of keys from both a first and a second set of keys. The processor is arranged to determine a subset of characters for text input, the determination based on the activation of a first key, the first key belonging to one of the first and second sets of keys. The processor is further arranged to determine a character for text input, the determination based on the activation of a second key, the second key belonging to the set of keys other to that which the first key belongs. The character for text input is selected from the subset of characters selected by the activation of the first key.

If the receiver receives a further activation of the first key, prior to activation of a second key, the processor may determine that the first selection of a subset of characters is cancelled. The processor may be further arranged to receive a further activation of a key from either of the first and second sets of keys, the further activation selecting a second subset of characters for text input.

The activation of the first key may be a press and release. The activation of the first key may be a key press. The method may be implemented such that activation of the second key must be made before first key press is released.

Releasing the first key before activation of the second key may result in the selection of a character for text input from the subset of characters. A different character may be selected by releasing the first key as compared to keeping the first key pressed and pressing a second key. Releasing the first key may select a character that could also be detected by pressing a second key.

The device may be connected to a TV. The device may be any one of a set-top-box, a games console or a TV. The device may be a remote control. The keys may be physical keys. The device may have a touch sensitive display, and the keys may be displayed on the display. The activation of a key may comprise a tap of an area of the touch sensitive display.

There is further provided a method for text input using a device having at least a first set of keys and a second set of keys. The method comprises receiving a press of a first key, the first key belonging to one of the first and second sets of keys, the press of the first key selecting a subset of characters. The method further comprises receiving a selection of a character for text input from the subset of characters selected by the press of the first key. The selection is received by one of: release of the first key; and receiving an activation of a second key, the second key belonging to the set of keys other than that to which the first key belongs.

There is further provided a device for receiving text input, the device comprising a receiver and a processor. The receiver is for receiving activations of keys from both a first and a second set of keys. The processor is for determining a subset of characters for text input, the determination based on the activation of a first key, the first key belonging to one of the first and second sets of keys. The processor further arranged to receive a determination of a character for text input, the character for text input selected from the subset of characters selected by the activation of the first key, the determination received by one of: release of the first key; and the activation of a second key, the second key belonging to the set of keys other than that to which the first key belongs.

### BRIEF DESCRIPTION OF THE DRAWINGS

A method and apparatus for text input via remote control will now be described, by way of example only, with reference to the accompanying drawings, in which:

FIG. 1 illustrates an apparatus for a set-top-box or a TV;

FIG. 2 illustrates an alternative apparatus for a set-top-box, a TV, or a control device;

FIG. 3 illustrates an alternative apparatus, the apparatus suitable for a remote control device;

FIG. 4 illustrates a further alternative apparatus also suitable for a remote control device;

FIG. 5 illustrates a method for text input;

FIG. 6 illustrates a further method for text input;

FIG. 7 illustrates an example key arrangement for text input via remote control;

FIG. 8 illustrates an alternative example key arrangement for text input via remote control; and

FIG. 9 illustrates a further alternative example key arrangement for text input via remote control.

### DETAILED DESCRIPTION

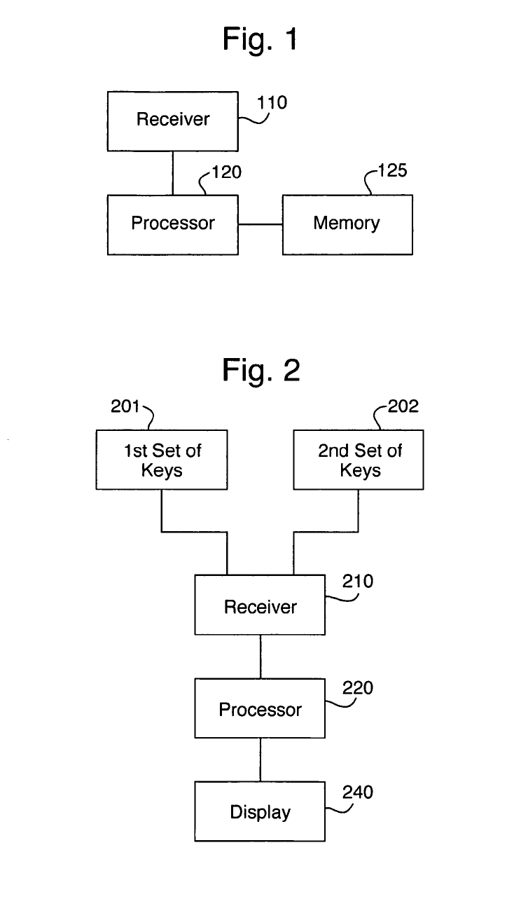

The method and apparatus disclosed herein provide a new apparatus for text input that is particularly suited to a remote control and watching television (TV) from a sofa. The method may be implemented using a variety of different apparatus arrangements, a few examples of which will be described below with reference to FIGS. 1 to 4.

FIG. 1 illustrates an arrangement which could be in a set-top-box or a TV. A receiver 110 receives signals from a remote control, the signals indicating button presses made on the remote control. The receiver 110 interprets these signals and passes on the indication of the button presses to a processor 120. The processor 120 processes the indications of button presses to identify character selections for text input. The text input is used by an application running on the processor 120. Any text input will be displayed in a graphical user interface (GUI) on a display of the TV or a display connected to the set-top-box.

The processor 120 is connected to a memory 125. The processor 120 is arranged to receive instructions which, when executed, causes the processor 120 to carry out the method described herein. The instructions may be stored on the memory 125.

FIG. 2 illustrates a further arrangement which could be in a set-top-box, a TV, or a control device. The arrangement of FIG. 2 comprises a first set of keys 201, a second set of keys 202, a receiver 210, a processor 220, and a display 240.

The first and the second set of keys 201 and 202 are arranged to receive key presses from a user. Signals indicating the key presses are received by the receiver 210, which interprets these signals and passes on the indication of the key presses to a processor 220. The processor 220 processes the indications of key presses to identify character selections for text input.

Where the processor 220 is part of a set-top-box or a TV, the text input is used by an application running on the processor 220. Any text input will be displayed in a graphical user interface (GUI) on a display 240 of the TV or a display 240 connected to the set-top-box.

In an alternative, the arrangement of FIG. 2 is in a remote control device, the remote control device having a display 240 itself. Where the remote control device is arranged to control a TV system, the TV system will have a primary display, and as such the display 240 of the remote control device would be a secondary display. The processor 220 of the remote control device is arranged to display a GUI on display 240. When the processor 220 processes the indications of key presses to identify character selections for text input, the text input is used by an application running on the processor 220. Any text input will be displayed in a graphical user interface (GUI) on the display 240 of remote control device.

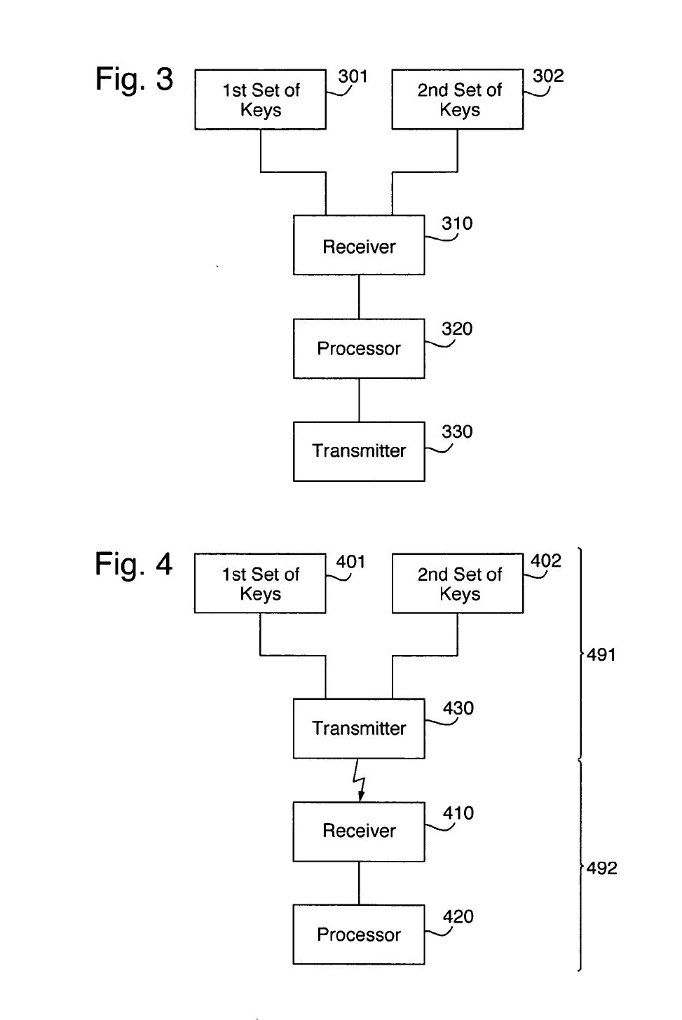

FIG. 3 illustrates an alternative arrangement of a remote control device. The arrangement of FIG. 3 comprises a first set of keys 301, a second set of keys 302, a receiver 310, a processor 320, and a transmitter 330.

The first and the second set of keys 301 and 302 are arranged to receive key presses from a user. Signals indicating the key presses are received by the receiver 310, which interprets these signals and passes on the indication of the key presses to a processor 320. The processor 320 processes the indications of key presses to identify character selections for text input. The processor then instructs the transmitter 330 to transmit a signal indicating the character for text input. The transmitter 330 is arranged to transmit signals to a system such as a set-top-box or a TV, the signals for commanding the set-top-box or TV.

FIG. 4 illustrates a further alternative arrangement for a remote control device. The arrangement of FIG. 4 comprises a remote control device 491 and a system 492 for receiving commands such as a set-top-box or a TV. remote control device 491 comprises a first set of keys 401, a second set of keys 402, and a transmitter 430. The system 492 comprises a receiver 410 and a processor 420.

The first and the second set of keys 401 and 402 are arranged to receive key presses from a user. Signals indicating the key presses are transmitted by the transmitter 430. The signals indicating key presses are received by the receiver 410 of the system 492. The receiver 410 interprets the transmitted signals and passes on an indication of the key presses to the processor 420. The processor 420 processes the indications of button presses to identify character selections for text input. The text input is used by an application running on the processor 420. Any text input will be displayed in a graphical user interface (GUI) on a display of or connected to the system 492.

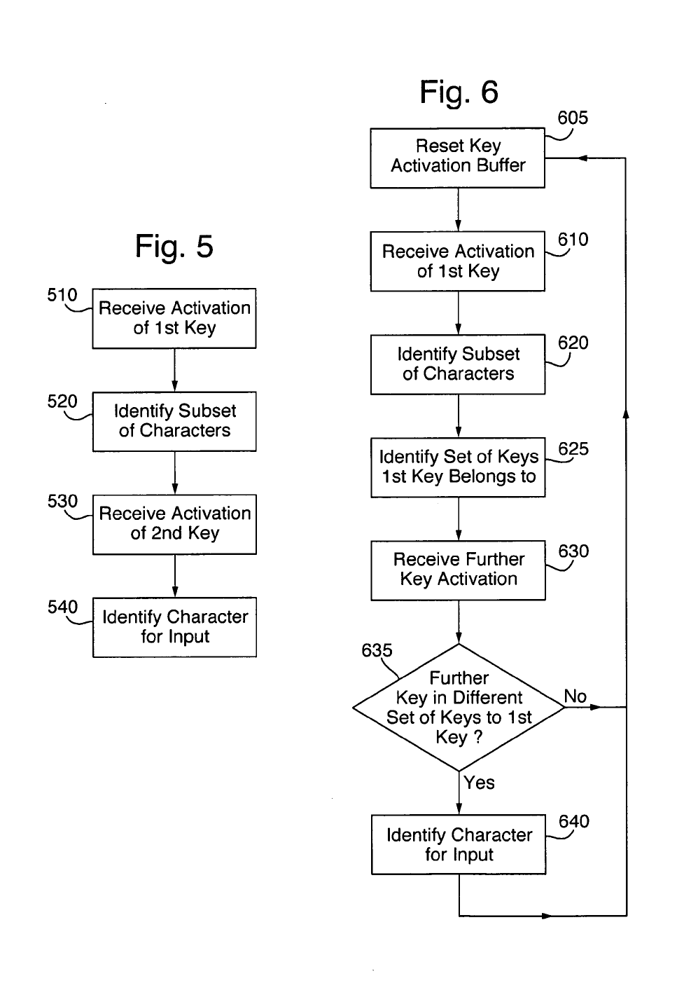

FIG. 5 illustrates a method of text input. The process begins at 510 where the activation of a first key is received. This activation is used at 520 to identify a subset of characters for text input. The subset of characters is a subset of the set of all characters available for text input; that set is determined by the user interface in operation. The set of all characters available for text input may comprise all letters of the alphabet plus some additional characters such as space “ ”, full-stop “.” and comma “,”. A full-stop is sometimes referred to as a period.

The activation of a second key is received at 530. This activation is used at 540 to identify a character for text input, the character being a member of the subset of characters that was identified at 520.

FIG. 6 illustrates a further method for text input. The process begins at 605 with the resetting of a key activation buffer. At 610 the activation of a first key is received. This activation is used at 620 to identify a subset of characters for text input. At 625 the set of keys that the first key belongs to is identified and recorded in the key activation buffer. The activation of a second key is received at 630. At 635 the set of keys that the second key belongs to is identified and a determination is made as to whether the set of keys that the second key belongs to is different to the set of keys that the first key belongs to. If the sets of keys are not different, then the character input is cancelled and the process returns to 605 where the key activation buffer is reset.

If, at 635, the sets of keys are determined to be different, then the activation of the second key is used at 640 to identify a character for text input, the character being a member of the subset of characters that was identified at 620. This character may then be input as required and the process returns to 605 where the key activation buffer is reset.

In an alternative method to that described in connection with FIG. 6, a determination that the second key belongs to the same set of keys as the set of keys to which that first key belongs results in selection of a character for text input. That is, activation of the first key results in the identification of a subset of characters for text input. One character of a plurality of members from this subset may be selected for text input by activating one of the plurality of keys from the other set of keys. However, one character from this subset may be selected for text input by activating the first key again.

The above alternative may be extended such that if the second key activation is from a key that is in the same set of keys as the first key, but a different key to the first key, then the process returns to 605 and the key activation buffer is reset.

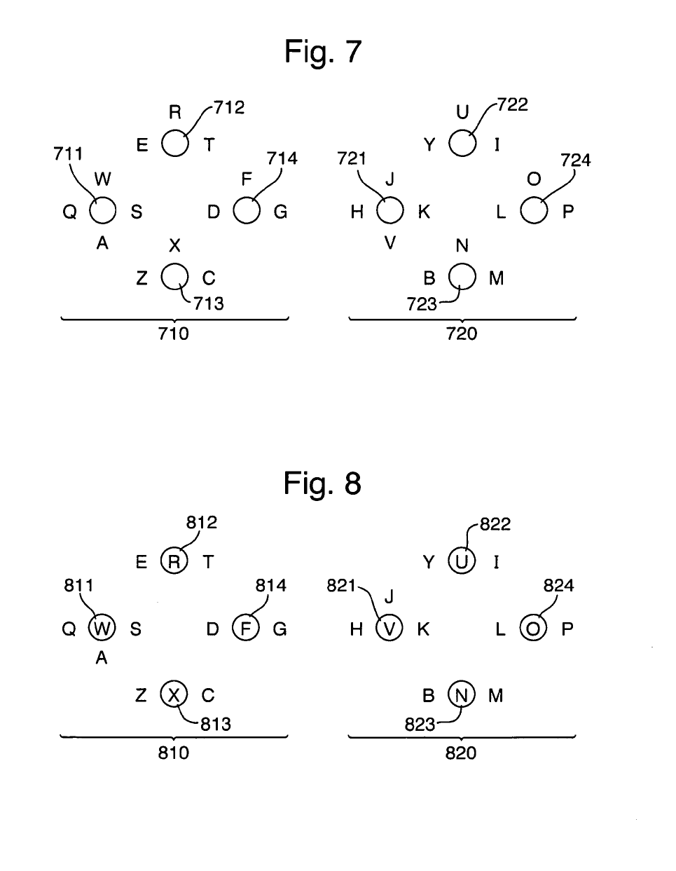

Some example key arrangements for implementing the text input method described herein are illustrated in FIGS. 7, 8 and 9. The keys are illustrated with the characters they are arranged to input displayed around the buttons. This text may be physically present on the material of a remote control that surrounds each key, or the text may be physically present on the key itself. Alternatively, the text may not be physically present on the device at all and instead displayed on a screen of a GUI when text input is being performed. The text around one set of keys may be displayed in an orientation matching the other set of keys to help the user distinguish which second key activation they should make to select a particular character for text input.

FIG. 7 illustrates a first set of keys 710 and a second set of keys 720. Each set of keys 710, 720 comprises 4 keys in a diamond formation. Such an arrangement is common on controllers for game consoles where one set of keys comprises a directional pad, and another set of keys comprises 4 action buttons intended for performing different actions. Such an arrangement of keys is also present on a conventional remote control which comprises direction buttons for menu navigation and number buttons channel entry, in this example, the number buttons 2, 4, 6, and 8 present a diamond formation as illustrated in FIG. 7.

The first set of keys 710 comprises 4 keys: a first key 711 for inputting Q, W, A or S; a second key 712 for inputting E, R or T; a third key 713 for inputting Z, X or C; and a fourth key 714 for inputting D, F or G. The second set of keys 720 comprises 4 further keys: a fifth key 721 for inputting H, J, V or K; a sixth key 722 for inputting Y, U or I; a seventh key 723 for inputting B, N or M; and an eighth key 724 for inputting L, O or P. The keys of FIG. 7 are suitable for implementing the method described in relation to FIG. 6.

The arrangement of FIG. 7, with two sets of four buttons gives 32 two-button combinations, where each button of a two-button combination is from a different set of keys. 6 potential character positions are left blank in FIG. 7, representing unused two-button combinations. The unused positions are at the bottom (or 6 o'clock) position of keys 712, 713, 714, 722, 723, and 724. These unused positions could be used for alternative characters such as punctuation space “ ”, full-stop “.” and comma “,”, or accented characters such as “ö” (“o” with an umlaut) or “å” (“a” with a ring diacritic).

FIG. 8 illustrates an alternate set of keys. The keys of FIG. 8 are suitable for use with the alternative method described above, whereby a determination that the second key belongs to the same set of keys as the set of keys to which that first key belongs results in selection of a character for text input. That is, the text input method where one key selects a subset of characters and a second key on another set of keys to the first key selects the character for text input; is used in conjunction with a method wherein a double press of the first key also selects a character for text input. In such an arrangement the subset of keys selected for text input by activation of the first key comprises the characters that may be selected by activating a key on the other set of keys, and the character that may be selected by activating the first key again.

FIG. 8 shows a first set of keys 810 and a second set of keys 820. Each set of keys 810, 820 comprises 4 keys in a diamond formation, much the same as the keys of FIG. 7. A difference between the keys of FIG. 7 and those of FIG. 8 is that the keys of FIG. 8 include a character displayed on the key. The character displayed on the key indicates the character that will be selected for text in put of that key is pressed twice. The character need not be physically present on the key, it could be physically present on the material surrounding the key and could be differentiated from the other characters in some way to indicate it may be selected by a double press of that key. As above, the text may not be physically present on the device at all, and instead displayed on a screen of a GUI when text input is being performed.

The first set of keys 810 comprises 4 keys: a first key 811 for inputting Q, W, A or S; a second key 812 for inputting E, R or T; a third key 813 for inputting Z, X or C; and a fourth key 814 for inputting D, F or G. The second set of keys 820 comprises 4 further keys: a fifth key 821 for inputting H, J, V or K; a sixth key 822 for inputting Y, U or I; a seventh key 823 for inputting B, N or M; and an eighth key 824 for inputting L, O or P. Characters W, R, X, F, V, U, N and O may be input by a double press of keys 811, 812, 813, 814, 821, 822, 823, and 824 respectively.

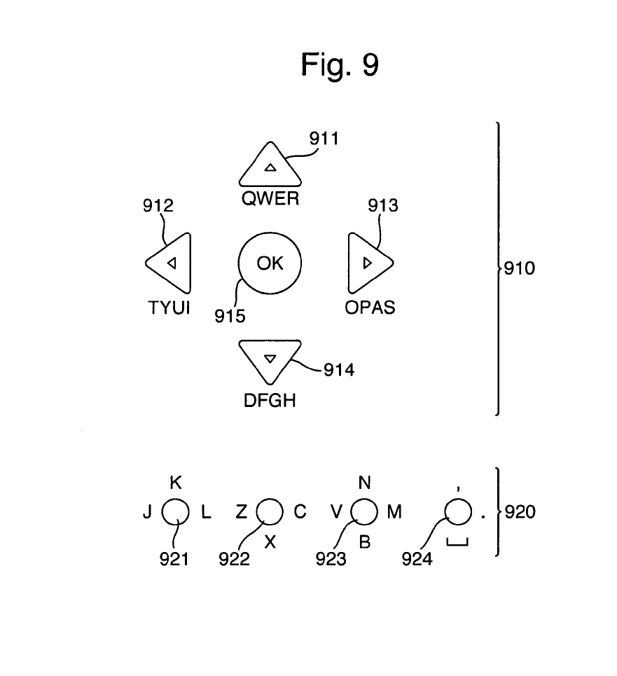

FIG. 9 illustrates a further alternative set of keys, comprising a first set of keys 910 and a second set of keys 920. The first set of keys comprise a menu navigation arrangement with 4 directional keys 911, 912, 913, 914 arranged in a diamond formation surrounding a fifth confirm, OK, or menu key 915. Key 915 is not used for text input in this embodiment. The second set of keys comprises a row of four keys 921, 922, 923, and 924. These four keys are the red, green, yellow and blue buttons traditionally used for Teletext navigation but now also used as shortcut keys for navigating EPGs. Such an arrangement is common in remote controls for TVs, set-top-boxes, DVD players and the like.

The first set of keys 910 comprises 4 keys used for text input: a first key 911 for inputting Q, W, E or R; a second key 912 for inputting T, Y, U or I; a third key 913 for inputting O, P, A or S; and a fourth key 914 for inputting D, F, G or H. The second set of keys 920 comprises 4 further keys: a sixth key 921 for inputting J, K or L; a seventh key 922 for inputting Z, X or C; an eighth key 923 for inputting V, N, B or M; and a ninth key 924 for inputting comma, space or full-stop.

The activation of the first key may be a press and release. However, in an alternative embodiment the activation of the first key is just a key press. This allows for the implementation of a requirement that the activation of the second key must be made before the first key press is released. The apparatus and method may then be extended to allow selection of certain characters by releasing the first key before activation of the second key. results in the selection of a character for text input from the subset of characters. Characters W, R, X, F, V, U, N and O using respective keys 811, 812, 813, 814, 821, 822, 823, and 824 of FIG. 8 may be input using this variant. It should be noted that a different character may be selected by releasing the first key as compared to keeping the first key pressed and pressing a second key. Releasing the first key may select a character that could also be detected by pressing a second key.

The method and apparatus disclosed herein is not limited to the button layout in the above examples. The layout of the characters above utilizes the well-known QWERTY layout and maps it to the button layout so that the user can learn the layout more quickly. The QWERTY layout may be implemented differently. Indeed, the layout of characters may alternatively be arranged in some other way, such as alphabetically.

The method and apparatus disclosed herein is easily implemented in a browser based system, where the browser receives all key events and can freely display whatever it desires on the screen. This may be implemented in an application on the receiving device without new firmware or hardware. The method and apparatus disclosed herein can also be implemented in native applications.

In an alternative embodiment the method is modified to include a statistical prediction algorithm. This algorithm can list the most probably words on the screen, combined with what button to press to select that word as input. The statistical prediction algorithm can also be used to detect and correct typographical errors. For example if the user is fast he might accidentally type the two buttons in the reversed order. If the buttons are pressed very closely in time the algorithm can be used to select the most likely character. For example if the user is typing “hello”, but the last character is typed by incorrectly pressing 712 before 724 with very close spacing in time, instead of inputting “T” the algorithm re-interprets the combination as it was meant, as 724 followed by 712 giving “O” and so corrects “hellt” to “hello”. There are numerous possibilities for implementing the statistical prediction functionality in the user interface for text input. For example, where the key arrangement of FIG. 9 is used, the fifth key 915 may be activated to indicate acceptance of a suggested variant.

The method and apparatus disclosed herein gives much faster text input than conventional methods. Once the user is familiar with the configuration of the characters he will be able to touch-type and the text input can become very fast.

The key input on the remote control may be combined with a user interface which provides visual feedback on the screen. The screen may show an outline of the keys, an indication of how they can be pressed in combination or sequence to produce the desired character. The screen may even show the current progress of selecting a character, such as which characters may be selected by each of the available second key presses.

The above embodiments have been described in the context of remote controls for TVs etc. It should be apparent that the above described methods and apparatus may equally be applied to a controller of a games console, for inputting text such as a user's name while using the games console. Indeed, the two sets of four keys, each set arranged in a diamond formation, maps well to many controllers for games consoles. Further, a set of four keys arranged in a diamond may be replaced by a joystick, where a move of the joystick left, right, up or down each signifies the activation of one of the four keys of the diamond.

The term “remote control” is used with reference to any device for receiving text input from a user. A remote control may be any user input device suitable for use with a device or system such as a TV, set-top box, games console, home theatre personal computer (HTPC), optical disc player, or media player.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. A method for text input using a device having at least a first set of keys, a second set of keys, and a screen, the method comprising:
receiving an activation of a first key, the first key belonging to one of the first and second sets of keys, the activation of the first key selecting a subset of characters;
displaying on the screen the subset of characters that may be selected by activation of a second key; and
receiving an activation of a second key, the second key belonging to the set of keys other than that to which the first key belongs, the activation of the second key selecting a character for text input from the subset of characters selected by the activation of the first key.

2. The method of claim 1, further comprising:
receiving a further activation of the first key prior to receiving an activation of a second key, and cancelling a first selection of a subset of characters in response thereto.

3. The method of claim 1, wherein the activation of the first key is a press and release.

4. The method of claim 1, wherein the activation of the first key is a key press.

5. The method of claim 4, wherein the activation of the second key must be made before first key press is released.

6. The method of claim 4, wherein receiving a release of the first key before an activation of the second key results in the selection of a character for text input from the subset of characters.

7. A non-transitory computer-readable medium, carrying instructions, which, when executed by computer logic, causes said computer logic to carry out the method defined by claim 1.

8. A device for receiving text input, the device comprising:
a receiver for receiving activations of keys from both a first and a second set of keys;
a processor for determining a subset of characters for text input, the determination based on the activation of a first key, the first key belonging to one of the first and second sets of keys;
a screen for displaying the subset of characters selected by activation of the first key; and
the processor further determining a character for text input, the determination based on the activation of a second key, the second key belonging to the set of keys other than that to which the first key belongs, wherein the character for text input is selected from the subset of characters selected by the activation of the first key.

9. The device of claim 8, wherein if the receiver receives a further activation of the first key, prior to activation of a second key, the processor determines that the first selection of a subset of characters is cancelled.

10. The device of claim 8, wherein the activation of the first key is a press and release.

11. The device of claim 8, wherein the activation of the first key is a key press.

12. The device of claim 11, wherein the activation of the second key must be made before the first key press is released.

13. The device of claim 11, wherein if the receiver receives a release of the first key before activation of the second key, the processor determines the selection of a character for text input from the subset of characters.

14. The device of claim 8, wherein the device is connected to a TV.

15. The device of claim 8, wherein the device is a set-top-box, a games console or a TV.

16. The device of claim 8, wherein the device is a remote control.

17. The device of claim 8, wherein the keys are physical keys.

18. The device of claim 8, wherein the device has a touch sensitive display, and the keys are displayed on the display.

19. The device of claim 18, wherein activation of a key comprises a tap of an area of the touch sensitive display.
